(19) United States
(12) Patent Application Publication
(10) Pub. No.: US 2009/0140957 A1
(43) Pub. Date: Jun. 4, 2009

(54) Pixel and organic light emitting display using the same

(76) Inventors: Yong-Sung Park, Suwon-si (KR); Deok-Young Choi, Suwon-si (KR); Do-Youb Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/217,720

(22) Filed: Jul. 7, 2008

(30) Foreign Application Priority Data
Dec. 4, 2007 (KR) 10-2007-0124949

(51) Int. Cl. G09G 3/30

(52) U.S. Cl. 345/76

(57) ABSTRACT

A pixel circuit with stable lamination is disclosed. A leakage current which would otherwise cause the voltage at the gate of the drive transistor to change, resulting in a change in the current to the OLED, is compensated for by an additional transistor.

### CROSS-REFERENCE TO RELATED APPLICATIONS

This application claims priority to and the benefit of Korean Patent Application No. 10-2007-0124949, filed on Dec. 4, 2007, in the Korean Intellectual Property Office, the entire content of which is incorporated herein by reference.

### BACKGROUND

1. Field

The field relates to a pixel and an organic light emitting display using the same capable of being applied in a high-resolution display because of the small size of the pixel.

2. Description of the Related Technology

With developments in technology related to thin film transistors and semiconductors active matrix type flat plate displays using a thin film transistor have widely been used. In particular, an organic light emitting display having excellent luminous efficiency, brightness, viewing angle, and a rapid response speed has been popular.

The organic light emitting display generates an image using a plurality of organic light emitting diodes (OLEDs). Each of the organic light emitting diodes includes an anode electrode, a cathode electrode and an organic light emitting layer positioned therebetween and light is emitted through recombination of electron-hole pairs.

In general, a pixel in the organic light emitting display determines the amount of current flowing to the organic light emitting diode using a voltage corresponding to a data signal. And, brightness is determined by the amount of current flowing to the organic light emitting diode. Also, the pixel includes a capacitor maintaining a voltage corresponding to the data signal for the time period of one frame. However, if leakage current is generated in the capacitor, the voltage maintained by the capacitor is lowered so that a desired amount of current does not flow to the organic light emitting diode. It causes a problem that brightness is deteriorated so that picture quality is deteriorated.

To address the problem, it is possible reduce the effect of the leakage current by increasing the capacitance and, therefore, the size of the capacitor. However, if the size of the capacitor is increased, it is difficult to make the size of the pixel small. Accordingly, there are many difficulties in fabricating an organic light emitting display having a high resolution.

### SUMMARY OF CERTAIN INVENTIVE ASPECTS

One aspect is a pixel, including a first transistor configured to control driving current from a first node to a second node according to a voltage at the gate electrode thereof, a second transistor configured to transfer a signal from a data line to the first node in response to a first scan signal, and a third transistor including a first electrode coupled to the second node, a second electrode coupled to a third node and a gate electrode coupled to a first scan line, the third transistor configured to selectively diode connect the first transistor according to the first scan line. The pixel also includes a capacitor having a first electrode coupled to a first pixel power supply and a second electrode coupled to the third node, the capacitor configured to maintain a voltage between the first pixel power supply and the third node. The pixel also includes a fourth transistor configured to selectively transfer an initializing signal to initialize the capacitor according to a second scan signal, a fifth transistor configured to selectively conduct the first pixel power to the first node according to a light emitting control signal, a sixth transistor configured to selectively conduct the driving current to an organic light emitting diode according to the light emitting control signal, and a diode connected in parallel with the capacitor such that the cathode of the diode is connected to the first pixel power supply.

Another aspect is an organic light emitting display, including a pixel unit including pixels configured to display images corresponding to data signals, scan signals, and light emitting control signals, a data driver configured to generate the data signals and to transfer them to the pixel unit, and a scan driver configured to generate the scan signals and the light emitting control signals and to transfer them to the pixel unit. The pixel includes a first transistor configured to control driving current from a first node to a second node according to a voltage at the gate electrode thereof, a second transistor configured to transfer a signal from a data line to the first node in response to a first scan signal, and a third transistor including a first electrode coupled to the second node, a second electrode coupled to a third node and a gate electrode coupled to a first scan line, the third transistor configured to selectively diode connect the first transistor according to the first scan line. The pixel also includes a capacitor having a first electrode coupled to a first pixel power supply and a second electrode coupled to the third node, the capacitor configured to maintain a voltage between the first pixel power supply and the third node. The pixel also includes a fourth transistor configured to selectively transfer an initializing signal to initialize the capacitor according to a second scan signal, a fifth transistor configured to selectively conduct the first pixel power to the first node according to a light emitting control signal, a sixth transistor configured to selectively conduct the driving current to an organic light emitting diode according to the light emitting control signal, and a diode connected in parallel with the capacitor such that the cathode of the diode is connected to the first pixel power supply.

Another aspect is a pixel, including a drive transistor, configured to control a current based on a voltage at the gate of the drive transistor, a capacitor connected to the gate of the drive transistor, the capacitor configured to store the voltage, and an organic light emitting diode, configured to emit light according to the current. The pixel also has one or more current leakage paths configured to provide a current to the capacitor, and a leakage compensation transistor coupled to the capacitor, where the leakage compensation transistor is configured to provide a current to the capacitor, where the current provided to the capacitor by the leakage compensation transistor is substantially of equal magnitude and opposite polarity as the current provided to the capacitor by the leakage paths.

### BRIEF DESCRIPTION OF THE DRAWINGS

The accompanying drawings, together with the specification, illustrate exemplary embodiments, and, together with the description, serve to explain the inventive aspects.

FIG. 1 is a block diagram of an organic light emitting display;

FIG. 2 is a circuit diagram showing an embodiment of a pixel in the organic light emitting display shown in FIG. 1;

FIG. 3 is a timing diagram showing the operation of the pixel shown in FIG. 2;

FIG. 4 is a circuit diagram showing another embodiment of a pixel in the organic light emitting display shown in FIG. 1; and

FIG. 5 is a timing diagram showing the operation of the pixel shown in FIG. 4.

### DETAILED DESCRIPTION OF CERTAIN INVENTIVE EMBODIMENTS

Hereinafter, certain exemplary embodiments will be described with reference to the accompanying drawings. Here, when a first element is described as being coupled to a second element, the first element may be not only directly coupled to the second element but may also be indirectly coupled to the second element via a third element. Further, some elements that are not essential to the complete understanding of the invention are omitted for clarity. Also, like reference numerals generally refer to like elements throughout.

Hereinafter, certain embodiments will be described with reference to the accompanying drawings.

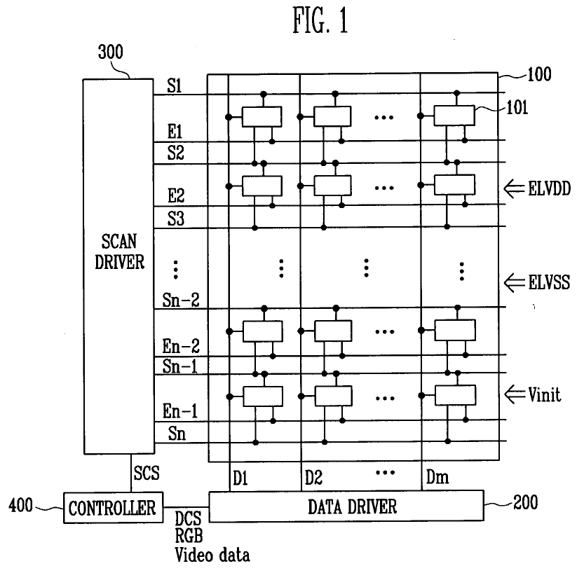

FIG. 1 is a block diagram of an organic light emitting display. Referring to FIG. 1, the organic light emitting display includes a pixel unit 100, a data driver 200, a scan driver 300, and a controller 400.

The pixel unit 100 includes a plurality of pixels 101, wherein each of the pixels 101 includes an organic light emitting diode (not shown) emitting light corresponding to the flow of current. And, the pixel unit 100 includes a plurality of scan lines S1, S2, . . . Sn-1, Sn arranged in a row direction and transferring scan signals, a plurality of light emitting control lines E1, E2, . . . En-1 arranged in a row direction and transferring light emitting control signals, and a plurality of data lines arranged in a column direction and transferring data signals. Also, the pixel unit 100 receives a first power ELVDD, a second power ELVSS, and an initializing signal Vinit from the outside. As shown, two scan signals are provided to each pixel 101. After the initializing signal is transferred to the pixel 101 through one of the two scan signals, the data signal is transferred into the pixel 101 by the other scan signal. The initializing scan signal transfers the data signal to a pixel row of a previous line.

The data driver 200 applies the data signal to the pixel unit 100. In this embodiment, data driver 200 receives an image signal (RGB Video data) having red, green, and blue components to generate the data signal. And, the data driver 200 is coupled to the data lines D1, D2, . . . Dm-1, Dm of the pixel unit 100 to apply the generated data signal to the pixel unit 100.

The scan driver 300 applies the scan signal and the light emitting control signal to the pixel unit 100. Scan driver 300 is coupled to the scan lines S1, S2, . . . Sn-1, Sn and the light emitting control lines E1, E2, . . . En1 to transfer the scan signal and the light emitting control signal to a specific row of the pixel unit 100. The data signal output from the data driver 200 is transferred to the pixel 101 to which the scan signal is transferred, so that driving current is generated in the pixel 101 to provide current to the organic light emitting diode.

The controller 400 generates control signals such as an RGB image signal (for RGB Video data), a data driver control signal DCS, a scan driver control signal, etc to transfer them to the data driver 200, the scan driver 300, etc.

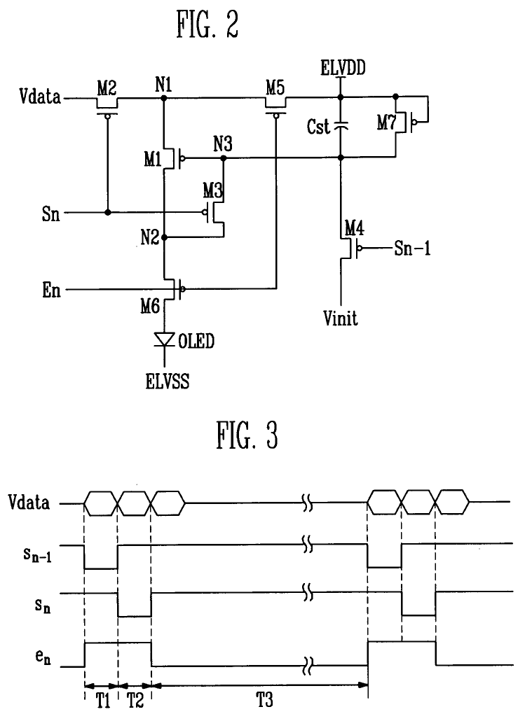

FIG. 2 is a circuit diagram showing a first embodiment of a pixel used in the organic light emitting display shown in FIG. 1. Referring to FIG. 2, the pixel includes an organic light emitting diode (OLED) and a peripheral circuit. The peripheral circuit includes a first transistor M1, a second transistor M2, a third transistor M3, a fourth transistor M4, a fifth transistor M5, a sixth transistor M6, a seventh transistor M7, and a capacitor Cst.

The first to seventh transistors M1 to M7 comprise source electrodes, drain electrodes and gate electrodes, and the capacitor Cst comprises first and second electrodes.

The source electrode of the first transistor M1 is coupled to a first node N1, the drain electrode thereof is coupled to a second node N2, and the gate electrode thereof is coupled to a third node N3.

The source electrode of the second transistor M2 is coupled to a data line Dm, the drain electrode thereof is coupled to the first node N1, and the gate electrode thereof is coupled to a first scan line Sn.

The source electrode of the third transistor M3 is coupled to the second node N2, the drain electrode thereof is coupled to the third node N3, and the gate electrode thereof is coupled to the first scan line Sn. Therefore, the third transistor M3 makes the electric potentials of the second node N2 and the third node N3 equal according to a first scan signal transferred through the first scan line Sn to diode-connect the first transistor M1.

The source electrode of the fourth transistor M4 is coupled to an initializing signal line Vint, the drain electrode thereof is coupled to the third node N3, and the gate electrode thereof is coupled to a second scan line Sn-1. Therefore, the fourth transistor M4 transfers an initializing signal to the third node N3 corresponding to a second scan signal transferred through the second scan line Sn-1, thereby initializing the voltage of the third node N3.

The source electrode of the fifth transistor M5 is coupled to a first pixel power supply line ELVDD, the drain electrode thereof is coupled to the first node N1, and the gate electrode thereof is coupled to a light emitting control line En. Therefore, the fifth transistor M5 selectively transfers a first pixel power ELVDD to the first node N1 according to a light emitting control signal transferred through the light emitting control line En.

The source electrode of the sixth transistor M6 is coupled to the second node N2, the drain electrode thereof is coupled to the organic light emitting diode OLED, and the gate electrode thereof is coupled to the light emitting control line En. Therefore, the sixth transistor M6 selectively transfers current supplied from the first transistor M1 to the organic light emitting diode OLED according to the light emitting control signal transferred through the light emitting control line En.

The source electrode and gate electrode of the seventh transistor M7 are coupled to the first pixel power supply line ELVDD, and the drain electrode thereof is coupled to the third node N3. That is, the source electrode and gate electrode of the seventh transistor M7 have the same electric potentials, and are coupled to the capacitor Cst in parallel. The seventh transistor M7 is diode-connected so that the direction from the third node N3 to the first pixel power supply ELVDD is a forward direction.

The first electrode of the capacitor Cst is coupled to the first pixel power supply line ELVDD, and the second electrode thereof is coupled to the third node N3. Since the voltage of the pixel power supply ELVDD transferred to the first electrode of the capacitor Cst is fixed, the capacitor Cst maintains the voltage of the third node N3, which is voltage transferred to the second electrode according to the leakage current to the capacitor Cst.

The anode electrode of the organic light emitting diode OLED is coupled to the drain electrode of the sixth transistor M6, and the cathode electrode thereof is coupled to a second pixel power supply line ELVSS. The organic light emitting diode OLED light emits corresponding to current supplied thereto.

FIG. 3 is a timing diagram showing the operation of the pixel shown in FIG. 2. Referring to FIG. 3, the pixel receives the first scan signal sn, the second scan signal sn-1, the light emitting control signal en and the data signal Vdata, and further receives the initializing signal vinit (not shown). That is, the pixel operates in response to the first scan signal sn, the second scan signal sn-1, the light emitting control signal en, the data signal Vdata, and the initializing signal vinit supplied thereto. In this embodiment, the first scan signal sn, the second scan signal sn-1, and the light emitting control signal are periodic signals. And, one frame comprises a first section T1, a second section T2, and a third section T3, wherein the third section is maintained until one frame is ended.

The first scan signal sn maintains a high state in the first section T1, a low state in the second section T2, and a high state in the third section. The second scan signal sn-1 maintains a low state in the first section T1, and a high state in the second section T2 and the third section T3. And, the light emitting control signal maintains a high state in the first section T1 and second section T2, and a low state in the third state T3.

In the first section T1, the fourth transistor M4 becomes an on-state because of the second scan signal sn-1. Accordingly, the voltage of the initializing signal vinit is transferred to the third node N3.

In the second section T2, the second transistor M2 and the third transistor M3 are turned on by the first scan signal sn. When the second transistor M2 is on, the data signal is transferred to the first node N1. And, when the third transistor M3 is on, the second node N2 and the third node N3 are electrically coupled so that the first transistor M1 is diode-connected, and the data signal is transferred to the third node N3. Therefore, a voltage corresponding to the data signal Vdata is transferred to the second electrode of the capacitor Cst so that the voltage of Equation 1 below exists between the source electrode and the drain electrode of the first transistor M1.

Vsg=ELVDD−(Vdata−Vth) [Equation 1]

Where Vsg indicates the voltage between the source electrode and the gate electrode of the first transistor M1, ELVDD indicates the voltage of the first power supply, Vdata indicates the voltage of the data signal, and Vth indicates the threshold voltage of the first transistor M1.

In the third section T3, the fifth transistor M5 and the sixth transistor M6 are turned on by the light emitting control signal en. As a result, current flows from the first pixel power supply to the organic light emitting diode OLED via the first node N1. The voltage corresponding to the above Equation 1 exists between the gate electrode and the source electrode of the first transistor M1. Therefore, current corresponding to Equation 2 below flows to the organic light emitting diode OLED.

$$\begin{matrix}{I}_{O L E D} - \frac{β}{2} {( Vgs - Vth )}^{2} = \frac{β}{2} {( \begin{matrix}Vdata - ELVDD + \\ Vth - Vth\end{matrix} )}^{2} \\ = \frac{β}{2} {( Vdata - ELVDD )}^{2}\end{matrix} \qquad [ Equation 2 ]$$

Where I_{OLED} indicates the current flowing to the organic light emitting diode OLED, Vgs indicates the voltage applied to the gate electrode of the first transistor M1, ELVDD indicates the voltage of the first pixel power supply, Vth indicates the threshold voltage of the first transistor M1, and the Vdata indicates the voltage of the data signal.

Therefore, the current flowing to the organic light emitting diode OLED flows independent of the threshold voltage of the first transistor M1.

At this time, ideally, the third transistor M3 and the fourth transistor M4 are off so that the voltage stored in the capacitor Cst is not changed until the initializing signal is again input. However, leakage current flows through the third transistor M3 and the fourth transistor M4 such that the voltage of the third node N3 is changed by the leakage current. Accordingly, when the voltage of the third node N3 is changed, the amount of the current flowing to the organic light emitting diode OLED is changes so that the brightness of the organic light emitting diode OLED is altered.

In order to solve the problem, the size of the capacitor Cst can be increased. However, if the size of the capacitor is increased, it is difficult keep the size of the pixel small. Accordingly, it is difficult to apply the solution to high resolution displays.

In order to solve the above problem, the seventh transistor M7 is coupled to the capacitor Cst in parallel wherein the seventh transistor M7 performs a role of a diode whose a reverse direction is the direction from the first pixel power supply ELVDD to the third node N3. In the same manner that that the leakage current is generated in the third transistor M3 and the fourth transistor M4, leakage current is generated in the seventh transistor M7. The leakage current generated in the seventh transistor M7 affects the voltage of the third node N3, counteracting the leakage of the third and fourth transistors M3 and M4, thereby substantially preventing the voltage of the third node N3 from being lowered. Accordingly, it is prevented that the amount of current flowing to the organic light emitting diode OLED is reduced. Although the size of the capacitor Cst is small, because the leakage current can be compensated for, it is possible to maintain the voltage despite the leakage. For this reason, it is possible to reduce the size of the pixel and thus, the pixel can be used in an organic light emitting display having high resolution.

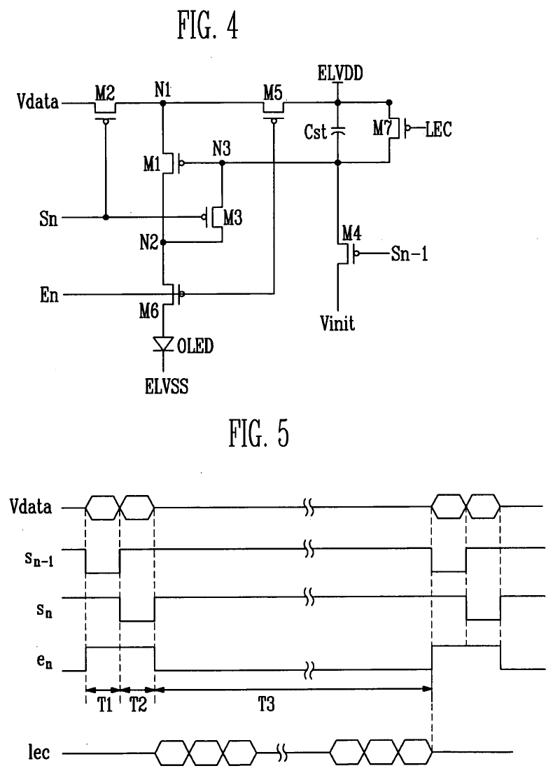

FIG. 4 is a circuit diagram showing another embodiment of a pixel used in the organic light emitting display shown in FIG. 1. Referring to FIG. 4, the pixel includes an organic light emitting diode OLED and a peripheral circuit. The peripheral circuit includes a first transistor M1, a second transistor M2, a third transistor M3, a fourth transistor M4, a fifth transistor M5, a sixth transistor M6, a seventh transistor M7, and a capacitor Cst.

The first to seventh transistors M1 to M7 comprise source electrodes, drain electrodes and gate electrodes, and the capacitor Cst comprises first and second electrodes.

The source electrode of the first transistor M1 is coupled to a first node N1, the drain electrode thereof is coupled to a second node N2, and the gate electrode thereof is coupled to a third node N3.

The source electrode of the second transistor M2 is coupled to a data line Dm, the drain electrode thereof is coupled to the first node N1, and the gate electrode thereof is coupled to a first scan line Sn.

The source electrode of the third transistor M3 is coupled to the second node N2, the drain electrode thereof is coupled to the third node N3, and the gate electrode thereof is coupled to the first scan line Sn. Therefore, the third transistor M3 makes the electric potentials of the second node N2 and the third node N3 same according to a first scan signal transferred through the first scan line Sn to diode-connect the first transistor M1.

The source electrode of the fourth transistor M4 is coupled to an initializing signal line Vint, the drain electrode thereof is coupled to the third node N3, and the gate electrode thereof is coupled to a second scan line Sn-1. Therefore, the fourth transistor M4 transfers an initializing signal to the third node N3 according to a second scan signal transferred through the second scan line Sn-1, thereby initializing the voltage of the third node N3.

The source electrode of the fifth transistor M5 is coupled to a first pixel power supply line ELVDD, the drain electrode thereof is coupled to the first node N1, and the gate electrode thereof is coupled to a light emitting control line En. Therefore, the fifth transistor M5 selectively transfers a first pixel power ELVDD to the first node N1 according to a light emitting control signal transferred through the light emitting control line En.

The source electrode of the sixth transistor M6 is coupled to the second node N2, the drain electrode thereof is coupled to the organic light emitting diode OLED, and the gate electrode thereof is coupled to the light emitting control line En. Therefore, the sixth transistor M6 selectively transfers current supplied from the first transistor M1 to the organic light emitting diode OLED according to the light emitting control signal transferred through the light emitting control line En.

The source electrode of the seventh transistor M7 is coupled to the first pixel power supply line ELVDD, the drain electrode thereof is coupled to the third node, and the gate electrode thereof is coupled to a current control line LEC through which a separate control signal is transferred. The current control line LEC transfers a current control signal. The current control signal is transferred from the controller shown in FIG. 1 through connections not shown in FIG. 1. The seventh transistor M7 is coupled to the capacitor Cst in parallel, and is selectively diode-connected so that the direction from the third node N3 to the first pixel power supply ELVDD is a forward direction.

The first electrode of the capacitor Cst is coupled to the first pixel power supply line ELVDD, and the second thereof is coupled to the third node N3. Since the voltage of the pixel power supply transferred to the first electrode of the capacitor Cst is fixed, the capacitor Cst maintains the voltage of the third node N3 according to the leakage current to the capacitor Cst.

The anode electrode of the organic light emitting diode OLED is coupled to the drain electrode of the sixth transistor M6, and the cathode electrode thereof is coupled to a second pixel power supply line ELVSS. The organic light emitting diode OLED emits light according to the current supplied thereto.

FIG. 5 is a timing diagram showing the operation of the pixel shown in FIG. 4. Referring to FIG. 5, the pixel receives the first scan signal sn, the second scan signal sn-1, the light emitting control signal en, the data signal Vdata, and the initializing signal vinit (not shown), and the pixel is operated in response to them. In this embodiment, the first scan signal sn, the second scan signal sn-1, and the light emitting control signal are periodic signals. And one frame comprises a first section T1, a second section T2, and a third section T3, where the third section is maintained until one frame is ended.

The first scan signal sn maintains a high state in the first section T1, a low state in the second section T2, and a high state in the third section. The second scan signal sn-1 maintains a low state in the first section T1, and a high state in the second section T2 and the third section T3. The light emitting control signal maintains a high state in the first section T1 and second section T2, and a low state in the third state T3.

In the first section T1, the fourth transistor M4 are turned on with the second scan signal sn-1. Thereby, the voltage of the initializing signal vinit is transferred to the third node N3.

In the second section T2, the second transistor M2 and the third transistor M3 are turned on with the first scan signal sn. If the second transistor M2 is on, the data signal is transferred to the first node N1. And, if the third transistor M3 is on, the second node N2 and the third node N3 are on so that the first transistor M1 is diode-connected. If the first transistor M1 is diode-connected, the data signal transferred to the first node N1 is transferred to the third node N3. Accordingly, a voltage corresponding to the data signal is transferred to the second electrode of the capacitor Cst so that the voltage corresponding to the above Equation 1 exists between the source electrode and the drain electrode of the first transistor M1.

In the third section T3, the fifth transistor M5 and the sixth transistor M6 are turned on by the light emitting control signal en. As a result, current flows from the first pixel power supply to the organic light emitting diode OLED via the first node N1. At this time, the voltage corresponding to the above Equation 1 is formed between the gate electrode and the source electrode of the first transistor M1. Therefore, current corresponding to the above Equation 2 flows in a direction from the first node N1 through the organic light emitting diode OLED.

Therefore, the current flowing through the organic light emitting diode OLED flows independent of the threshold voltage of the first transistor M1.

The third transistor M3 and the fourth transistor M4 are off, so that the voltage stored in the capacitor Cst should not change until the initializing signal is again input. However, leakage current flows through the third transistor M3 and the fourth transistor M4 so that the voltage of the third node N3 is changed by the leakage current. As described above, if the voltage of the third node N3 is changed, the amount of current flowing to the organic light emitting diode OLED is changed so that the brightness of the organic light emitting diode OLED is altered.

Therefore, as shown in FIG. 2, in order to solve the above problem, the seventh transistor M7 is coupled to the capacitor Cst in parallel, where the seventh transistor M7 performs a role of a diode whose a reverse direction is the direction from the first pixel power supply to the third node N3.

However, the difference with FIG. 2 is that the on/off state of the seventh transistor M7 is determined with the current control signal lec transferred through a current control line LEC, which is a separate control line. The reason for controlling the seventh transistor M7 using the current control signal lec, is that the magnitudes of the threshold voltages of the third transistor M3 and the fourth transistor M4 are not necessarily the same. If there is a difference between the threshold voltage of the seventh transistor M7 and the threshold voltages of the third transistor M3 and the fourth transistor M3, the magnitude of the leakage current generated in the seventh transistor M7 and the magnitudes of the leakage currents generated in the third transistor M3 and the fourth transistor M4 are different if the same voltage is applied. Accordingly, there is a problem that the amount of current exiting the third node N3 (that is, the amount of the leakage current generated in the third transistor M3 and the fourth transistor M4) and the amount of current entering the third node N3 (that is, the amount of the leakage current generated in the seventh transistor M7) are different so that the voltage of the third node N3 is not constant. Therefore, in order to the solve the problem, the voltage of the current control signal lec controlling the seventh transistor M7 is adjusted so that the amount of the leakage current according to the difference of the threshold voltages is adjusted, thereby allowing the voltage of the third node N3 to be substantially constant.

With the pixel and the organic light emitting display using the pixel, it is possible to prevent the voltage corresponding to the data signal and stored in the capacitor from being changed by compensating for the leakage current of the capacitor. As a result, it is possible to use a small storage capacitor so that small pixel size and high resolution are possible.

While the present invention has been described in connection with certain exemplary embodiments, it is to be understood that the invention is not limited to these embodiments, but, on the contrary, is intended to cover various modifications and arrangements.

What is claimed is:

1. A pixel, comprising:
a first transistor configured to control driving current from a first node to a second node according to a voltage at the gate electrode thereof;
a second transistor configured to transfer a signal from a data line to the first node in response to a first scan signal;
a third transistor comprising a first electrode coupled to the second node, a second electrode coupled to a third node and a gate electrode coupled to a first scan line, the third transistor configured to selectively diode connect the first transistor according to the first scan line;
a capacitor comprising a first electrode coupled to a first pixel power supply and a second electrode coupled to the third node, the capacitor configured to maintain a voltage between the first pixel power supply and the third node;
a fourth transistor configured to selectively transfer an initializing signal to initialize the capacitor according to a second scan signal;
a fifth transistor configured to selectively conduct the first pixel power to the first node according to a light emitting control signal;
a sixth transistor configured to selectively conduct the driving current to an organic light emitting diode according to the light emitting control signal; and
a diode connected in parallel with the capacitor such that the cathode of the diode is connected to the first pixel power supply.

2. The pixel as claimed in claim 1, wherein the diode comprises a seventh transistor having a source electrode and a gate electrode that are coupled to the first pixel power supply, and a drain electrode that is coupled to the third node.

3. The pixel as claimed in claim 1, wherein the diode comprises a seventh transistor having a source electrode that is coupled to the first pixel power supply, a drain electrode that is coupled to the third node, and a gate electrode that is coupled to a current control line through which a current control signal is transferred.

4. The pixel as claimed in claim 1, wherein the third node is configured to receive leakage current from the diode, such that the voltage of the third node is substantially prevented from being lowered.

5. The pixel as claimed in claim 3, wherein the current control signal is adjusted based at least in part on the difference between the threshold of the seventh transistor and the threshold voltage of the third transistor.

6. An organic light emitting display, comprising:
a pixel unit including pixels configured to display images corresponding to data signals, scan signals, and light emitting control signals;
a data driver configured to generate the data signals and to transfer them to the pixel unit; and
a scan driver configured to generate the scan signals and the light emitting control signals and to transfer them to the pixel unit,
wherein the pixel includes:
a first transistor configured to control driving current from a first node to a second node according to a voltage at the gate electrode thereof;
a second transistor configured to transfer a signal from a data line to the first node in response to a first scan signal;
a third transistor comprising a first electrode coupled to the second node, a second electrode coupled to a third node and a gate electrode coupled to a first scan line, the third transistor configured to selectively diode connect the first transistor according to the first scan line;
a capacitor comprising a first electrode coupled to a first pixel power supply and a second electrode coupled to the third node, the capacitor configured to maintain a voltage between the first pixel power supply and the third node;
a fourth transistor configured to selectively transfer an initializing signal to initialize the capacitor according to a second scan signal;
a fifth transistor configured to selectively conduct the first pixel power to the first node according to a light emitting control signal;
a sixth transistor configured to selectively conduct the driving current to an organic light emitting diode according to the light emitting control signal; and
a diode connected in parallel with the capacitor such that the cathode of the diode is connected to the first pixel power supply.

7. The organic light emitting display claimed in claim 6, wherein the diode comprises a seventh transistor having a source electrode and a gate electrode that are coupled to the first pixel power supply, and a drain electrode that is coupled to the third node.

8. The organic light emitting display claimed in claim 6, wherein the diode comprises a seventh transistor whose source electrode is coupled to the first pixel power supply, drain electrode is coupled to the third node, and whose gate electrode is coupled to a current control line through which a current control signal is transferred.

9. The organic light emitting display claimed in claim 6, wherein the third node is configured to receive leakage current from the diode, such that the voltage of the third node is substantially prevented from being lowered.

10. The organic light emitting display claimed in claim 8, wherein the current control signal is adjusted based at least in part on the difference between the threshold of the seventh transistor and the threshold voltage of the third transistor.

11. The organic light emitting display claimed in claim 6, wherein the second scan signal is output from the scan driver after the first scan signal is output from the scan driver.

12. A pixel, comprising:
a drive transistor, configured to control a current based on a voltage at the gate of the drive transistor;
a capacitor connected to the gate of the drive transistor, the capacitor configured to store the voltage;
an organic light emitting diode, configured to emit light according to the current;
one or more current leakage paths configured to provide a current to the capacitor; and
a leakage compensation transistor coupled to the capacitor, wherein the leakage compensation transistor is configured to provide a current to the capacitor,
wherein the current provided to the capacitor by the leakage compensation transistor is substantially of equal magnitude and opposite polarity as the current provided to the capacitor by the leakage paths.

13. The pixel of claim 12, wherein the gate and the drain of the leakage compensation transistor are connected to the same voltage.

14. The pixel of claim 13, wherein the same voltage is a pixel power voltage.

15. The pixel of claim 12, wherein the gate and the drain of the leakage compensation transistor are selectively connected to the same voltage.

16. The pixel of claim 12, wherein the leakage paths comprise a transistor configured to diode connect the drive transistor.

17. The pixel of claim 12, wherein the leakage paths comprise a transistor configured to initialize the capacitor.

18. The pixel of claim 12, wherein the gate of the leakage compensation transistor is driven with a voltage selected so that the voltage at the gate of the drive transistor is substantially constant.

19. The pixel of claim 12, wherein the leakage paths provide a positive current away from the capacitor.

20. The pixel of claim 12, wherein the leakage compensation transistor provides a positive current to the capacitor.
